(19) United States
(12) Patent Application Publication
(10) Pub. No.: US 2025/0284461 A1
(43) Pub. Date: Sep. 11, 2025

(54) EXPONENTIAL FUNCTION CALCULATION METHOD, EXPONENTIAL FUNCTION CALCULATION SYSTEM, AND EXPONENTIAL FUNCTION CALCULATION CIRCUIT

(71) Applicant: NEUCHIPS CORPORATION, Hsinchu City (TW)

(72) Inventors: Shen-Jui Huang, Hsinchu County (TW); I-Chen Chen, Hsinchu County (TW)

(73) Assignee: NEUCHIPS CORPORATION, Hsinchu City (TW)

(21) Appl. No.: 18/629,843

(22) Filed: Apr. 8, 2024

(30) Foreign Application Priority Data
Mar. 7, 2024 (TW) 113108423

(51) Int. Cl. G06F 7/556; G06F 1/03; G06F 7/02; G06F 7/535

(52) U.S. Cl. CPC G06F 7/556; G06F 1/0307; G06F 7/02; G06F 7/535

(57) ABSTRACT

Disclosed are exponential function calculation method, exponential function calculation system, and exponential function calculation circuit for calculating an exponential function value of an input value. The exponential function calculation method includes: dividing the input value as a sum of an integer value and a decimal value; representing the integer value by an integer bit string with a first length, and representing the decimal value by a decimal bit string with a second length; looking up a first table to obtain a first value corresponding to an exponent function value of the integer value according to the integer bit string, and interpolating to obtain an interpolation value corresponding to an exponent function value of the decimal value according to the decimal bit string; and calculating an output value corresponding to an exponent function value of the input value according to a product of the first value and the interpolation value.

### CROSS-REFERENCE TO RELATED APPLICATION

This application claims the priority benefit of Taiwan application serial no. 113108423, filed on Mar. 7, 2024. The entirety of the above-mentioned patent application is hereby incorporated by reference herein and made a part of specification.

### BACKGROUND

### Technical Field

The disclosure relates to a method, a system, and a circuit, and in particular to an exponential function calculation method, an exponential function calculation system, and an exponential function calculation circuit.

### Description of Related Art

With the widespread use in the field of artificial intelligence, one of the important functions, softMax function, used in the deep learning self-attention model, has also been widely used. Since the softMax function uses a large number of exponential computation, existing methods often require a large amount of power consumption to achieve higher calculation accuracy while implementing computations.

### SUMMARY

The disclosure provides an exponential function calculation method, an exponential function calculation system, and an exponential function calculation circuit, which can effectively reduce power consumption while achieving high accurate calculations.

The exponential function calculation method of the disclosure is configured to an exponential function value with an input value as an exponent. The exponential function calculation method includes: dividing the input value as a sum of an integer value and a decimal value; representing the integer value by an integer bit string with a first length, and representing the decimal value by a decimal bit string with a second length; looking up a first table to obtain a first value corresponding to an exponent function value of the integer value according to the integer bit string, and interpolating to obtain an interpolation value corresponding to an exponent function value of the decimal value according to the decimal bit string; and calculating an output value corresponding to an exponent function value of the input value according to a product of the first value and the interpolation value.

The exponential function calculation circuit of the disclosure is configured to calculate an exponential function value with an input value as an index. The exponential function calculation circuit includes a first lookup circuit, an interpolation calculation circuit, and a multiplication circuit. The first lookup circuit is configured to receive an integer bit string corresponding to an integer value divided by the input value and looks up a first table to obtain a first value corresponding to an exponential function of the integer value according to the integer bit string. The interpolation calculation circuit is configured to receive a decimal bit string corresponding to a decimal value divided by the input value and interpolates to obtain an interpolation value corresponding to an exponent function value of the decimal value according to the decimal bit string. The multiplication circuit is configured to calculate an output value corresponding to an exponential function value of the input value according to a product of the first value and the interpolation value.

The exponential function calculation system of the disclosure is configured to calculate an exponential function value with an input value as an exponent. The exponential function calculation system includes an input circuit, a format converter, and an exponential function calculation circuit. The input circuit is configured to receive an input floating point number and a maximum floating point number and subtracts the maximum floating point number from the input floating point number to calculate an input data configured to represent the input value, where the input data is in a floating point number format. The format converter is configured to divide the input value as a sum of an integer value and a decimal value, represents the integer value by an integer bit string with a first length, and represents the decimal value by a decimal bit string with a second length. The exponential function calculation circuit is configured to look up a first table to obtain a first value corresponding to an exponential function value of the integer value according to the integer bit string, interpolates to obtain an interpolation value corresponding to an exponential function value of the decimal value, and calculates an output value corresponding to an exponent function value of the input value according to a product of the first value and the interpolation value.

Based on the above, the exponential function calculation method, the exponential function calculation system, and the exponential function calculation circuit of the disclosure may calculate the output value corresponding to the exponential function value of the input value by looking up the table and interpolating, which reduces the power consumption effectively while achieving high accurate calculations.

### BRIEF DESCRIPTION OF THE DRAWINGS

FIG. 1 is a block diagram of an exponential function calculation system according to an embodiment of the disclosure.

FIG. 2 is a block diagram of an exponential function calculation circuit according to an embodiment of the disclosure.

FIG. 3 is a flow chart of an exponential function calculation method according to an embodiment of the disclosure.

### DESCRIPTION OF THE EMBODIMENTS

Generally, in some computation ways to calculate exponential functions, when doing the calculation of the exponential function, a softMax function subtracts an input value from a maximum value of the batch of data to generate a negative number, and then calculates an exponential function of the negative number. A result of the exponential function of the negative number is used to perform a computation of the softMax function, thereby avoiding an excessively large output value. In some computation methods, in order to maintain the accuracy of the computation result, the negative number is stored in a floating point number format. In this case, a calculation circuit of the softMax function needs to expand the negative number by Taylor series, and afterwards, the calculation result of the exponential function of the negative number may be calculated by a large number of multipliers and adders. In some embodiments, an exponential function calculation method, an exponential function calculation circuit, and an exponential function calculation system of the disclosure may store the generated negative number as calculation data in a fixed point number format, looking up a table, and interpolate by the calculation data. Looking up the table and interpolating may effectively reduce the number of the multipliers and the adders, while the calculation result of the softMax function is still accurately calculated.

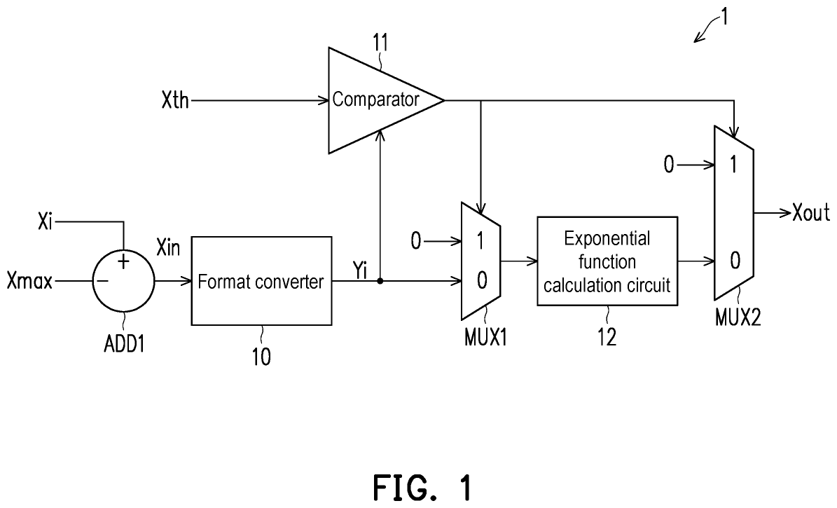

FIG. 1 is a block diagram of an exponential function calculation system according to an embodiment of the disclosure. Generally, an exponential function calculation system 1 in FIG. 1 may receive an input floating point number Xi and calculate a calculation result of an exponential function with the input floating point number Xi as an exponent according to a preset rule or a formula. In some embodiments, the exponential function calculation system 1 in FIG. 1 may calculate a calculation result of substituting the input floating point number Xi into the softMax function. As shown in FIG. 1, the exponential function calculation system 1 includes an adder ADD1, a format converter 10, a comparator 11, an exponential function calculation circuit 12, and multiplexers MUX1 and MUX2. Simply put, the adder ADD1 may be configured to receive the input floating point number Xi and subtract a maximum floating point number Xmax with the maximum value of the batch of data from the input floating point number Xi, thereby calculating the input data Xin of the input value. Since the input floating point number Xi and the maximum floating point number Xmax are both in floating point number formats, the input data Xin calculated by the adder ADD1 is still in the floating point number format.

Specifically, after receiving the input data Xin, the format converter 10 may convert the input data Xin into calculation data Yi in a fixed point number format. Specifically, the format converter 10 may first divide the input value Xin as a sum of an integer value and a decimal value, where the integer value may be a negative integer less than or equal to zero, and the decimal value may be a positive decimal greater than or equal to zero and less than one. Next, the format converter 10 may represent the integer value by an integer bit string with a first length and represent the decimal value by a decimal bit string with a second length. In this way, the format converter 10 may represent the input data Xin having the input value by an integer bit string and a decimal bit string with fixed bit lengths and store the input data Xin as the calculation data Yi in the fixed point number format.

The exponential function calculation circuit 12 may receive the calculation data Yi by the format converter 10 and look up a first table according to the integer bit string. Since the first table records the exponential function values calculated by using different negative integers as exponents, the exponential function calculation circuit 12 may look up the first table to obtain a first value calculated by using the negative integer as the exponent and the Euler number as the base according to the integer bit string. Moreover, the exponential function calculation circuit 12 may interpolate to obtain a second value corresponding to an exponential function value of the decimal value according to the decimal bit string. The exponential function calculation circuit 12 may calculate the output value by multiplying the first value by the second value, and the output value approximates a value calculated by using the input value as the exponent and the Euler number as the base.

In addition, under the circumstance that the input value is a negative number and is used as the exponent, when the negative integer of the input value is too small, the calculation result of the exponential function is close to zero. Therefore, the exponential function calculation system 1 may initially determine whether the input value is too low by the comparator 11 and the multiplexers MUX1 and MUX2 and directly set the output value generated by the exponential function calculation circuit 12 as zero accordingly.

The comparator 11 is coupled to the format converter 10. The multiplexer MUX1 is coupled between an output of the format converter 10 and an input of the exponential function calculation circuit 12. The multiplexer MUX2 is coupled to an output of exponential function calculation circuit 12. The comparator 11 may be configured to receive the integer bit string of the calculation data Yi and compare the value of the integer bit string with a default threshold value Xth. When determining that the value of the integer bit string is less than the default threshold value Xth, the comparator 11 may control the multiplexer MUX1 to set the input of the exponential function calculation circuit 12 as zero and control the multiplexer MUX2 to block the output of the exponential function calculation circuit 12; instead, zero is an output as an output value Xout. In this way, when the input value is too low, through the joint manipulation of the comparator 11 and multiplexers MUX1 and MUX2, the exponential function calculation system 1 may directly skip the calculation process of the exponential function calculation circuit 12 and directly set the output value as zero to speed up the overall computation process. In addition, although not shown in FIG. 1, in some embodiments, an output of the comparator 11 may also be provided to an enable end of the exponential function calculation circuit 12 to suspend the operation of the exponential function calculation circuit 12 when the input value is too low and directly set the output value as zero to save power consumption through the manipulation of the multiplexers MUX1 and MUX2.

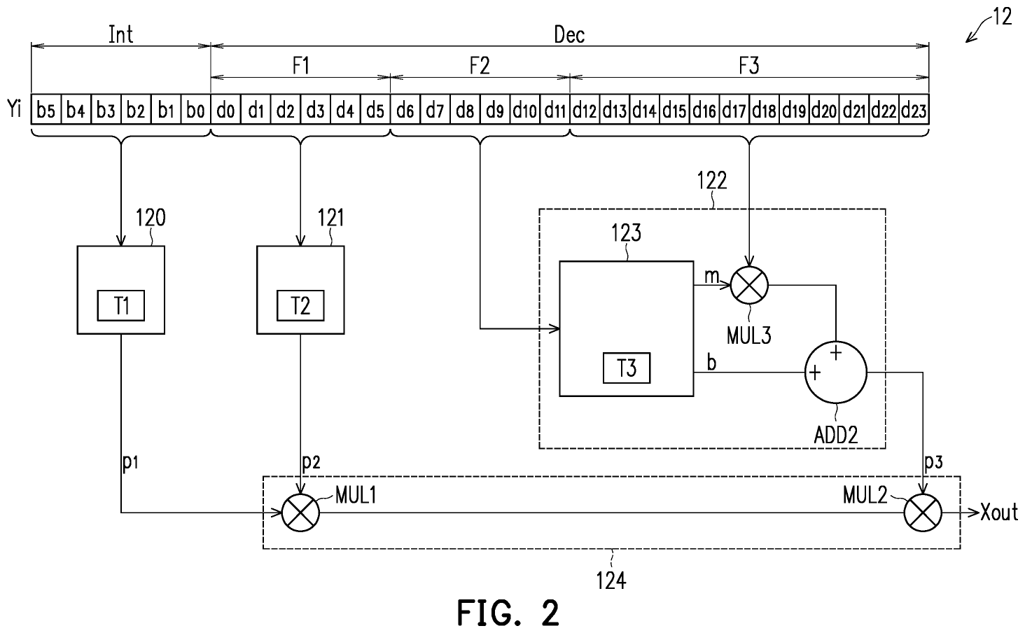

FIG. 2 is a block diagram of an exponential function calculation circuit according to an embodiment of the disclosure. The exponential function calculation circuit 12 includes lookup circuits 120 and 121, an interpolation calculation circuit 122, and a multiplication circuit 124.

Specifically, the calculation data Yi received by the exponential function calculation circuit 12 includes an integer bit string Int and a decimal bit string Dec. The integer bit string Int1 includes six-bits, b5˜b0, which are configured to represent or approximate a negative integer value. The decimal bit string Dec includes twenty-four bits, d23˜d0, which are configured to represent or approximate decimal values.

The lookup circuit 120 stores a table T1, and the table T1 records exponential function values calculated by using different negative integers as exponents, so the lookup circuit 120 may look up the table T1 by using the integer bit string as an index to obtain a value p1 with the negative integer as an exponent and the Euler number as the base.

The decimal bit string Dec is divided into a first decimal bit string F1 to a third decimal bit string F3 in bit order, where the first decimal bit string F1 is in the highest bit order, a second decimal bit string F2 is in the second, and the third decimal bit string F3 is in the lowest bit order. Further, since a table T2 records the exponential function values calculated by using different decimal values as exponents, the lookup circuit 121 may look up the table T2 by using the first decimal bit string F1 as an index to obtain a value p2 with the first decimal bit string F1 as an exponent and the Euler number as the base.

The second decimal bit string F2 and the third decimal bit string F3 are provided to the interpolation calculation circuit 122 to calculate a value p3, so that the values p1 to p3 are multiplied to generate an output value Xout. Specifically, the interpolation calculation circuit 122 includes a lookup circuit 123, a multiplier MUL3, and an adder ADD2. The lookup circuit 123 may search a table T3 stored in the lookup circuit 123 by using the second decimal bit string F2 in higher bit order as an index. Since the slope values and the intercept values corresponding to different decimal values are stored in the table T3, the lookup circuit 123 may find out a slope value m and an intercept value b corresponding to the decimal value of the second decimal bit string F2 by looking up the table T3. Through the joint manipulation of the multiplier MUL3 and the adder ADD2, the interpolation calculation circuit 122 may interpolate to obtain a value p3 according to the values of the second decimal bit string F2 and the third decimal bit string F3.

Finally, by the multipliers MUL1 and MUL2 of the multiplication circuit 124, the values p1 to p3 may be multiplied to calculate the output value Xout so as to calculate the calculation result of the exponential function with the input value as the exponent and the Euler number as the base.

The operation of the exponential function calculation system 1 in FIG. 1 and the exponential function calculation circuit 12 in FIG. 2 are described below by taking the input data Xin with a value of −2.747 as an example.

$${e}^{- 2.747} = {e}^{- 3 + 0.253} \qquad ( 1 )$$

As shown in the above equation (1), when receiving the input data Xin having the value of −2.747, the format converter 10 first divides the value of −2.747 into a negative integer value of −3 and a decimal value of 0.253. The negative integer value may be in a signed number format or an unsigned number format and may be represented as the integer bit string Int of the calculation data Yi in FIG. 2. On the other hand, the decimal value of 0.253 may be represented in a binary format as the decimal bit string Dec of 010000-001100-010010-011011, which has, for example, twenty-four bits in total. The first to sixth bits are divided into the first decimal bit string F1, the seventh to twelfth bits are divided into the second decimal bit string F2, and the thirteenth to twenty fourth bits are divided into the third decimal bit string F3.

Further, the lookup circuits 120 and 121 of the exponential function calculation circuit 12 may respectively look up the tables T1 and T2 to obtain the values p1 and p2 according to the integer bit string Int and the first decimal bit string F1. On the other hand, the interpolation calculation circuit 122 may calculate the interpolation value according to the second decimal bit string F2 and the third decimal bit string F3.

$${e}^{- 2.747} = {e}^{- 3} \cdot {e}^{0.253} = {e}^{- 3} \cdot {e}^{16 / 64} \cdot {e}^{0.192 / 64} \qquad ( 2 )$$

Specifically, the decimal bit string Dec is divided into the first decimal bit string F1 and the remaining second decimal bit string F2 and the third decimal bit string F3, which is equivalent to what is shown in the above equation (2). The decimal value of 0.253 is divided into a value of 16/64 and a value of 0.192/64, where the value of 16/64 is represented by the first decimal bit string F1, and the value of 0.192/64 is jointly represented by the second decimal bit string F2 and the third decimal bit string F3.

In this embodiment, the value of 0.192/64 jointly represented by the second decimal bit string F2 and the third decimal bit string F3 may be further subdivided into sixty-four numerical segments for looking up the table and interpolating. That is, the table T3 stores the slope value and the starting intercept value corresponding to the sixty-four numerical segments, and the second decimal string F2 of the six-bits may be used as an index to search which numerical segment the value of 0.192/64 falls into and may find out the slope value m and the intercept value b of the numerical segment accordingly. In this way, the interpolation calculation circuit 122 may finally multiply the value of the third decimal bit string F3 by the slope value m and add the intercept value b to calculate the interpolation result of the second decimal bit string F2 and the third decimal bit string F3 so as to obtain the corresponding value p3. Lastly, the values p1 to p3 are multiplied by the multipliers MUL1 to MUL3 to calculate the output value Xout calculated with the input data Xin as the exponent and the Euler number as the base.

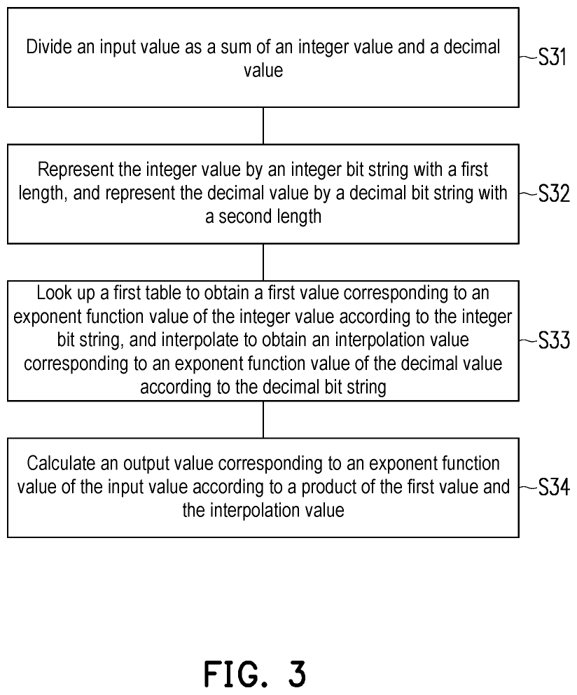

FIG. 3 is a flow chart of an exponential function calculation method according to an embodiment of the disclosure. The exponential function calculation method in FIG. 3 may be executed by the exponential function calculation system 1 in FIG. 1 and the exponential function calculation circuit 12 in FIG. 2.

The exponential function calculation method in FIG. 3 includes steps S31 to S34. In step S31, the format converter 10 may receive the input data Xi in the floating point number format and divide the input value as the sum of the integer value and the decimal value accordingly. In step S32, the format converter 10 may represent the integer value by the integer bit string Int with the first length and represent the decimal value by the decimal bit string Dec with the second length. In this way, the integer value may be converted and stored as the calculation data Yi in the fixed point number format. In step S33, the exponential function calculation circuit 12 may look up the table T1 to obtain the value p1 (that is, the first value) of the exponential function value corresponding to the integer value according to the integer bit string Int and interpolate to obtain the value p3 (that is, the interpolation value) of the exponential function value corresponding to the decimal value according to the decimal bit string Dec. In step S34, the exponential function calculation circuit 12 may calculate the output value Xout according to a product of the value p1 multiplied by the value p3.

In the aforementioned embodiment, the decimal value is divided into the first decimal bit string F1 to the third decimal bit string F3, the value p2 is obtained by the first decimal bit string F1 looking up the table T2, and the slope value m and the intercept value b is obtained by the second decimal bit string F2 looking up the table T3 to interpolate with the value of the third decimal bit string F3, but the disclosure is not limited thereto. For example, the decimal bit string Dec may be divided into more or fewer segments of decimal bit strings, and the number of tables to be looked up may be adjusted accordingly, as long as the exponential function calculation circuit 12 interpolates the calculation by using the last segment of the decimal bit string Dec. Also, the slope value and the intercept value used in interpolating calculation may be obtained by the former segment of the decimal bit string Dec looking up the table or may be a default slope value and the intercept value. For example, the exponential function calculation circuit 12 may multiply the value of the decimal bit string Dec by the default slope value and add the intercept value to interpolate the calculation. In other words, the exponential function calculation circuit 12 may divide the decimal bit string Dec into two or more segments of the decimal bit strings, look up the table, and interpolate the calculation.

In other embodiments, the format converter 10 may also divide the input data Xin in other ways. For example, the format converter 10 may divide the value of the input data Xin as the sum of the negative integer and the negative decimal and generate the integer bit string Int and the decimal bit string Dec accordingly. Therefore, different dividing methods should fall within the scope of the modified embodiments of the disclosure.

In some embodiments, the format converter 10 in FIG. 1 may, for example, divide the received input data Xin in the floating point number format into the calculation data Yi in the fixed point number format by a logic circuit and a wiring connection. In addition, the lookup circuits 120 to 123 in FIG. 2 include memories for storing the tables T1 to T3, and read circuits for accessing the memories. The lookup circuits 120 to 123 may be integrated into a single circuit structure, or may be distributed circuit structures.

To sum up, the exponential function calculation method, the exponential function calculation circuit, and the exponential function calculation system of the disclosure may calculate the exponential function value with the input value as the exponent by looking up the table and interpolating. In this way, the input value originally represented in the floating point number format may be represented in the fixed point number format, thereby reducing the memory resource requirements of the overall calculation process effectively. In addition, by looking up and interpolating the calculation of the exponential function values, the number of the multipliers and the adders used in the whole circuits may be effectively reduced, and the power consumption of the overall computation may be reduced without affecting the accuracy of the computation result.

What is claimed is:

1. An exponential function calculation method, configured to calculate an exponential function value with an input value as an exponent, the exponential function calculation method comprising:
dividing the input value as a sum of an integer value and a decimal value;
representing the integer value by an integer bit string with a first length, and representing the decimal value by a decimal bit string with a second length;
looking up a first table to obtain a first value corresponding to an exponent function value of the integer value according to the integer bit string, and interpolating to obtain an interpolation value corresponding to an exponent function value of the decimal value according to the decimal bit string; and
calculating an output value corresponding to an exponent function value of the input value according to a product of the first value and the interpolation value.

2. The exponential function calculation method according to claim 1, wherein the first length and the second length are fixed, and the exponential function calculation method comprises:
storing the integer bit string and the decimal bit string as a calculation data in a fixed point number format.

3. The exponential function calculation method according to claim 1, comprising:
comparing a value of the integer bit string with a default threshold value to set the output value as zero in response to the value of the integer bit string being less than the default threshold value.

4. The exponential function calculation method according to claim 1, comprising:
dividing the decimal bit string into a first decimal bit string and a second decimal bit string in bit order; and
interpolating to obtain the interpolation value according to the second decimal bit string in lower bit order.

5. The exponential function calculation method according to claim 4, comprising:
looking up a second table to obtain a slope value and an intercept value according to the second decimal bit string.

6. The exponential function calculation method according to claim 5, comprising:
dividing the decimal bit string into a third decimal bit string which is smaller than the first decimal bit string and the second decimal bit string in bit order; and
multiplying a value of the third decimal bit string by the slope value and adding the intercept value to calculate the interpolation value.

7. The exponential function calculation method according to claim 4, comprising:
looking up a third table to obtain a second value according to the first decimal bit string; and
calculating the output value by multiplying the first value, the second value, and the interpolation value.

8. The exponential function calculation method according to claim 1, wherein the input value is less than or equal to zero, the integer value is an integer less than or equal to zero, and the decimal value is between zero and one.

9. An exponential function calculation circuit, configured to calculate an exponential function value with an input value as an index, comprising:
a first lookup circuit, configured to receive an integer bit string corresponding to an integer value divided by the input value and looking up a first table to obtain a first value corresponding to an exponential function of the integer value according to the integer bit string; and
an interpolation calculation circuit, configured to receive a decimal bit string corresponding to a decimal value divided by the input value and interpolating to obtain an interpolation value corresponding to an exponent function value of the decimal value according to the decimal bit string; and
a multiplication circuit, configured to calculate an output value corresponding to an exponential function value of the input value according to a product of the first value and the interpolation value.

10. The exponential function calculation circuit according to claim 9, wherein the decimal bit string is divided into a first decimal bit string and a second decimal bit string in bit order, and the interpolation calculation circuit is configured to:
interpolate to obtain the interpolation value according to the second decimal bit string in lower bit order.

11. The exponential function calculation circuit according to claim 10, wherein the interpolation calculation circuit comprises:
a second lookup circuit, configured to look up a second table to obtain a slope value and an intercept value according to the second decimal bit string.

12. The exponential function calculation circuit according to claim 11, wherein the decimal bit string is further divided into a third decimal bit string which is smaller than the first decimal bit string and the second decimal bit string in bit order, and the interpolation calculation circuit comprises:
a first multiplier, configured to multiply a value of the third decimal bit string by the slope value; and
an adder, configured to add an output value of the first multiplier and the intercept value to calculate the interpolation value.

13. The exponential function calculation circuit according to claim 10, further comprising:
a third lookup circuit, configured to look up a third table to obtain a second value according to the first decimal bit string,
wherein the multiplication circuit comprises:
a second multiplier, configured to multiply the first value and the second value; and
a third multiplier, configured to multiply an output value of the second multiplier and the interpolation value to calculate the output value.

14. The exponential function calculation circuit according to claim 9, wherein the input value is less than or equal to zero, and the integer value is an integer less than or equal to zero, and the decimal value is between zero and one.

15. An exponential function calculation system, configured to calculate an exponential function value with an input value as an exponent, the exponential function calculation system comprising:
an input circuit, configured to receive an input floating point number and a maximum floating point number, and subtracting the maximum floating point number from the input floating point number to calculate an input data configured to represent the input value, wherein the input data is in a floating point number format;
a format converter, configured to divide the input value as a sum of an integer value and a decimal value, representing the integer value by an integer bit string with a first length, and representing the decimal value by a decimal bit string with a second length; and
an exponential function calculation circuit, configured to look up a first table to obtain a first value corresponding to an exponential function value of the integer value according to the integer bit string, interpolating to obtain an interpolation value corresponding to an exponential function value of the decimal value, and calculating an output value corresponding to an exponent function value of the input value according to a product of the first value and the interpolation value.

16. The exponential function calculation system according to claim 15, wherein the first length and the second length are fixed, and the format converter is configured to store the integer bit string and the decimal bit string after being divided from the input value as a calculation data in a fixed point number format.

17. The exponential function calculation system according to claim 15, comprising:
a comparator, configured to compare a value of the integer bit string with a default threshold value to set the output value as zero when finding out that the value of the integer bit string is less than the default threshold value.

18. The exponential function calculation system according to claim 17, comprising:
a first multiplexer, coupled between an output of the format converter and an input of the exponential function calculation circuit; and
a second multiplexer, coupled to an output of the exponential function calculation circuit,
wherein when comparing and finding out that the value of the integer bit string is less than the default threshold value, the comparator controls the first multiplexer to set the input of the exponential function calculation circuit as zero, and controls the second multiplexer to set the output of the exponential function calculation circuit as zero.
